(19) United States
(12) Patent Application Publication
(10) Pub. No.: US 2006/0244417 A1
(43) Pub. Date: Nov. 2, 2006

(54) Battery

(76) Inventors: Chung-Hung Tsai, Taipei (TW); Chih-Pu Tsai, Taipei (TW)

Correspondence Address: BRUCE H. TROXELL;SUITE 1404, 5205 LEESBURG PIKE, FALLS CHURCH, VA, 22041, US

(21) Appl. No.: 11/399,354

(22) Filed: Apr. 7, 2006

(30) Foreign Application Priority Data
Apr. 28, 2005 (TW) 094113643

(51) Int. Cl. H02J 7/00

(52) U.S. Cl. 320/112

(57) ABSTRACT

A battery including two sets of terminals, in a battery replacement operation, a battery with a low charge mounted in a carrier is partially removed from the carrier while one set of terminals remain in electrical contact with contacts of the carrier. A fully charged battery is inserted into the carrier and electrically connected to the carrier with one of two sets of terminals prior to completely removing the battery with the low charge. During the battery replacement operation the carrier continues a normal operation.

### 1. FIELD OF THE INVENTION

The present invention relates to a battery, more particularly to a battery having two sets of terminals adapted to connect to a portable device (e.g., portable computer, MP3 player, iPod, digital camera, portable medical equipment, remote control, or the like) such that the portable device continues its normal operation while a battery replacement is being performed.

### 2. BACKGROUND OF THE INVENTION

A wide variety of electronic products are available due to technical advances in electronics in recent years. Such electronic products include portable devices such as mobile phones, PDA (personal digital assistants), portable computer, MP3 players, iPods, digital cameras, portable medical equipment, remote controls, or the like. The fast development of these portable devices not only brings a lot of convenience but also is becoming an integral part of our daily lives and work. Thus, it is impossible to do without them.

Conventionally, such a portable device is powered by one or more battery cells. Electrical energy stored in a battery may be consumed quickly, if the device is operated frequently or for a long time. Thus, battery (e.g., a rechargeable battery) replacement may occur often particularly in a place where AC power is not easily obtained or charging the battery is not easy.

Typically, these devices are provided with a feature for measuring and displaying a remaining power of the battery, so that a user may know the remaining power of the battery, allowing the battery to be replaced before the power is completely consumed.

Typically, the device (e.g., mobile phone) must be turned off and subsequently turned on during a battery replacement operation. For example, a user may connect a charger to a power outlet and then plug a connector at an end of a cord of the charger into a charging socket of a mobile phone prior to charging, when the user determines that the battery is about to be consumed or is completely consumed. However, the user has to replace the consumed battery with a fully charged battery if a power outlet is not available. To change the battery, the user has to perform a number of steps including turning off the phone, removing the consumed battery, installing a new battery, turning on, input password including password or PIN card or SIM card, and waiting for connection to base stations in the battery replacement. This is quite a tedious process. Moreover, a user has to consider that data may be lost if a battery replacement is performed while a PDA, a notebook computer, or the like is running.

Solutions to the above problems include increasing capacity of battery and decreasing the number of times the battery must be recharged or replaced. However, the cost of increasing battery capacity is very high. Also, eliminating the steps of turning off and turning on a portable device is not possible based on the latest technology.

A typical battery is provided with only one set of terminals. The set of terminals is adapted to electrically connect to a corresponding set of contacts in a battery compartment of an electrical device (i.e., carrier). The electrical connection of the terminals and the contacts is interrupted during the battery replacement operation. That is, the battery is not able to support a temporary power to the carrier during the battery replacement operation. Thus, a need for improvement exists.

### SUMMARY OF THE INVENTION

It is therefore an object of the present invention to provide a battery comprising two sets of terminals whereby during a battery replacement operation a battery from which power has been consumed (drained battery) can be partially removed from the carrier while still maintaining electrical contact with the carrier. A fully charged battery can be inserted into the carrier and electrically connected to the carrier by one of the two sets of terminals thereof before the drained battery is completely removed from the carrier.

On object of the present invention is to form the two sets of terminals in predetermined positions such that the battery replacement operation can be performed without interrupting power being provided to the carrier.

Another object of the present invention is to form the two sets of terminals as a single one. The single set of terminals of a fully charged battery is adapted to electrically connect to the contacts of the carrier and the single set of terminals of the drained battery remain electrically connected to the contacts of the carrier until the battery replacement operation is completed.

These objectives, features and advantages of the present invention will become apparent from the following detailed description taken with the accompanying drawings.

### BRIEF DESCRIPTION OF THE DRAWINGS

FIG. 1 is a perspective view of a first preferred embodiment of a battery according to the invention;

FIG. 2 is a side view illustrating a battery replacement operation when the battery of the invention is mounted in a carrier;

FIG. 3 is a perspective view of a second preferred embodiment of the battery according to the invention where the battery is about to be inserted into a battery compartment of a mobile phone;

FIG. 4 is a perspective view illustrating a battery replacement operation; and

FIG. 5 is a perspective view of a third preferred embodiment of the battery according to the invention.

### DETAILED DESCRIPTION OF THE PREFERRED EMBODIMENTS

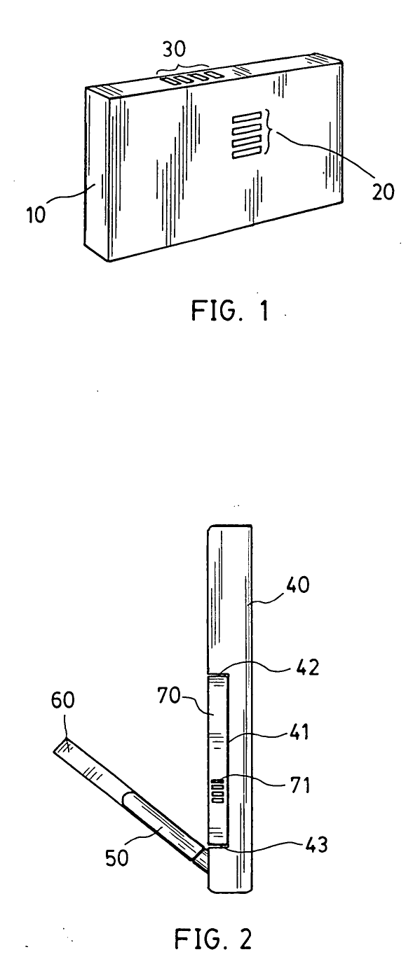

Referring to FIGS. 1 and 2, a battery 10, according to a first embodiment of the present invention, includes two sets of terminals 20 and 30. The battery 10 is adapted to mount in an electrical device (hereinafter called a carrier) 40.

Referring to FIG. 2 specifically, the carrier 40 is provided with a hinged clamp member 50 and which has circuitry electrically connected to the carrier 40. The clamp member 50 and thus a battery 60 to be replaced (i.e., a drained battery) are adapted to pivot about a hinge axis to form an angle about the carrier 40. Also, one set of terminals 30 of the battery 60 is able to supply electrically to the carrier 40 through contacts on the clamp member 50 during the pivoting operation. At this time, a new battery (i.e., a fully charged battery) 70 is inserted into a battery compartment of the carrier 40. Once inserted, one set of terminals of the battery 70 is electrically connected to contacts on the carrier 40. The contacts are provided on a top surface 42, an inner surface 41, or a bottom surface 43 of the battery compartment of the carrier 40. Once inserted, the battery 70 is adapted to supply electricity to the carrier 40. The other set of terminals 71 of the battery 70 are adapted to electrically connect to the clamp member 50 after removing the battery 60 and pivoting the clamp member 50 back to its normal, original position in the carrier 40. At this position, the clamp member 50 is electrically connected to the new battery 70.

Following the same procedure detail above, in a subsequent battery replacement operation, the battery 70 continues to supply electricity to the carrier 40 by electrically connecting the other set of terminals 71 to the contacts of the clamp member 50.

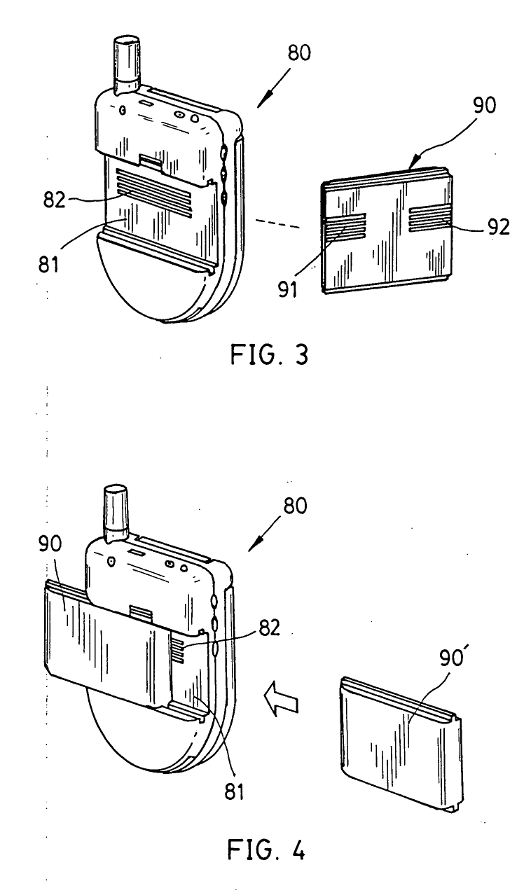

Referring to FIGS. 3 and 4, a battery 90 in accordance with a second preferred embodiment of the invention is shown. A battery compartment 81 is formed in the back of a mobile phone 80. A set of contacts 82 is formed on the battery compartment 81. The set of contacts 82 forms an elongated rectangle (i.e., having elongated electrical contacts). The battery 90 is shaped to conform to a shape of the battery compartment 81. The battery 90 has two sets of terminals 91 and 92. The two sets of terminals 91 and 92 are electrically connected to the set of contacts 82 for supplying electricity to the mobile phone 80 when the battery 90 is mounted in the battery compartment 81. When the battery 90 is mounted in the battery compartment 81, at least one of the sets of terminals 91 and 92 is electrically connected to the set of contacts 82 for supplying electricity to the mobile phone. As shown in FIG. 4, the other set of terminals 92 first enters the mobile phone 80.

Referring to FIG. 4, during the battery replacement operation (i.e., replacing a drained battery 90) the battery 90 is slid a distance toward a left of the carrier. At this time, one set of terminals 91 (not shown) is electrically connected to the set of contacts 82 of the mobile phone 80. That is, the battery 90 is still supplying electricity to the mobile phone 80. A new battery 90′ is ready to be inserted into the battery compartment 81. Once inserted, the other set of terminals 92 (not shown) is electrically connected to the set of contacts 82 for supplying electricity to the mobile phone 80. At this point, the battery 90 can be removed without interrupting the operation of the phone. Finally, the new battery 90′ is moved to a predetermined position in the battery compartment 81 for continuing a normal operation of the mobile phone 80.

As illustrated in FIGS. 2, 3 and 4, the battery of the present invention has two sets of terminals, such that one set of terminals of the drained battery is always electrically connected to the set of contacts of the carrier prior to electrically connecting the other set of terminals of the new battery to the set of contacts of the carrier (i.e., the carrier being in an operating state is able to continue its normal operation while a battery replacement is being performed).

The two sets of terminals of the battery are located in positions corresponding to positions of the set of contacts of the carrier or the clamp member. However, the invention is not limited to the above configurations as long as the carrier remains in a normal operating state while a battery replacement is being performed.

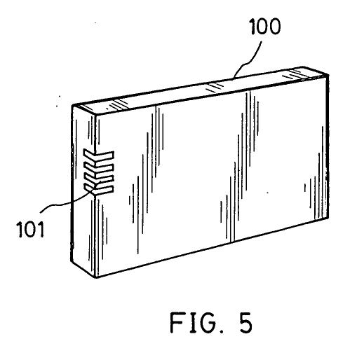

In FIG. 5, a third preferred embodiment of the present invention in which a parallelepiped battery 100 has one set of terminals 101 formed on an edge thereof. The set of terminals 101 has two features: a first feature is that the set of terminals 101 of a new battery 100 is adapted to electrically connect to a set of contacts of a carrier; and a second feature is that the set of terminals 101 of a battery about to be consumed is always electrically connected to a set of contacts of a clamp member while a battery replacement is being performed. Hence, electricity is always suppled to the carrier while a battery replacement is being performed such that the carrier being in an operating state is able to continue its normal operation. The third preferred embodiment of the battery having two sets of terminals formed on two adjacent surfaces and connected as a single terminal still falls within the scope of the invention.

In summary, a battery according to the present invention has two sets of terminals adapted to mount in a carrier such that the carrier being in an operating state is able to continue its normal operation while a battery replacement is being performed.

While the invention herein disclosed has been described by means of specific embodiments, and numerous modifications, variations can be made thereto by those skilled in the art without departing from the scope and spirit of the invention set forth in the claims.

What is claimed is:

1. A battery assembly comprising:
a battery having two sets of terminals located on an exterior thereof.

2. The battery assembly according to claim 1, further comprising an electronic device, the battery is selectively connected to and disconnected from a set of terminals of the electronic device.

3. The battery assembly according to claim 2, further comprising a hinged clamp member pivotally connected to the electronic device and having a set of clamp member terminals electrically connected to the electronic device.

4. The battery assembly according to claim 2, wherein the battery has a size corresponding to a size of a battery compartment of the electronic device.

5. The battery assembly according to claim 2, wherein, when the battery is connected to the electronic device, at least one set of terminals of the two sets of terminals is electrically connected to the set of terminals of the electronic device.

6. The battery assembly according to claim 1, wherein the two sets of terminals are spaced apart on one surface of the exterior of the battery.

7. The battery assembly according to claim 1, wherein the two sets of terminals include a first set of terminals located on a first surface of the exterior of the battery and a second set of terminals located on a second surface of the exterior of the battery.

8. The battery assembly according to claim 7, wherein the first set of terminals has one end connected to the second set of terminal.

9. The battery assembly according to claim 2, further comprising a replacement battery assembly having:
a) a replacement battery having a size corresponding to the size of the battery compartment of the electronic device, the replacement battery being selectively connected to and disconnected from the electronic device; and
b) two sets of terminals located on an exterior of the replacement battery;
wherein, when the replacement battery is connected to the electronic device, at least one of the two sets of terminals is electrically connected to a set of terminals of the electronic device.

10. The battery assembly according to claim 9, wherein during a battery replacement operation two sets of terminals including one of the two sets of terminals of the battery and one of the two sets of terminals of the replacement battery are electrically connected to the electronic device providing an uninterrupted power to the electronic device.

11. The battery assembly according to claim 9, further comprising a hinged clamp member pivotally connected to the electronic device and having a set of clamp member terminals electrically connected to the electronic device.

12. The battery assembly according to claim 11, wherein during a battery replacement operation one of the two sets of terminals of the battery is electrically connected to the set of clamp member terminals of the hinged clamp member and one of the two sets of terminals of the replacement battery is electrically connected to the set of terminals of the electronic device providing an uninterrupted power to the electronic device.

13. The battery assembly comprising:
a battery assembly having:
a) a battery having a size corresponding to a size of a battery compartment of the electronic device, the battery being selectively connected to and disconnected from the electronic device; and
b) two sets of terminals located on an exterior of the battery;
wherein, when the battery is connected to the electronic device, at least one of the two sets of terminals is electrically connected to a set of terminals of the electronic device.

14. The battery assembly according to claim 13, wherein the two sets of terminals are spaced apart on one surface of the exterior of the battery.

15. The battery assembly according to claim 13, wherein the two sets of terminals include a first set of terminals located on a first surface of the exterior of the battery and a second set of terminals located on a second surface of the exterior of the battery.

16. The battery assembly according to claim 15, wherein the first set of terminals has one end connected to the second set of terminal.

17. The battery assembly according to claim 13, further comprising a replacement battery assembly having:
a) a replacement battery having a size corresponding to the size of the battery compartment of the electronic device, the replacement battery being selectively connected to and disconnected from the electronic device; and
b) two sets of terminals located on an exterior of the replacement battery;
wherein, when the replacement battery is connected to the electronic device, at least one of the two sets of terminals is electrically connected to a set of terminals of the electronic device.

18. The battery assembly according to claim 17, wherein during a battery replacement operation two sets of terminals including one of the two sets of terminals of the battery and one of the two sets of terminals of the replacement battery are electrically connected to the electronic device providing an uninterrupted power to the electronic device.

19. The battery assembly according to claim 17, further comprising a hinged clamp member pivotally connected to the electronic device and having a set of clamp member terminals electrically connected to the electronic device.

20. The battery assembly according to claim 19, wherein during a battery replacement operation one of the two sets of terminals of the battery is electrically connected to the set of clamp member terminals of the hinged clamp member and one of the two sets of terminals of the replacement battery is electrically connected to the set of terminals of the electronic device providing an uninterrupted power to the electronic device.
